(19) United States
(12) Patent Application Publication
(10) Pub. No.: US 2020/0326218 A1
(43) Pub. Date: Oct. 15, 2020

(54) Thermal Flowmeter

(71) Applicant: Hitachi Automotive Systems, Ltd., Hitachinaka-shi, Ibaraki (JP)

(72) Inventors: Masashi FUKAYA, Tokyo (JP); Shinobu TASHIRO, Hitachinaka-shi (JP); Akira UENODAN, Hitachinaka-shi (JP); Naoki SAITO, Hitachinaka-shi (JP); Tomoaki SAITO, Hitachinaka-shi (JP)

(21) Appl. No.: 16/090,656

(22) PCT Filed: Apr. 13, 2017
(86) PCT No.: PCT/JP2017/015070

§ 371 Date: Oct. 2, 2018

(30) Foreign Application Priority Data
May 31, 2016 (JP) 2016-108874

(51) Int. Cl. G01F 1/684

(52) U.S. Cl. CPC G01F 1/6842

(57) ABSTRACT

Provided is a thermal flowmeter enabling a measurement error while fluid is pulsating, to fall below that of a conventional one. The thermal flowmeter includes a sub-passage configured to take in part of the fluid flowing in a main passage; and a flow-amount measuring unit disposed in the sub-passage. The sub-passage has a first passage provided on a measurement face side of the flow-amount measuring unit; a second passage provided on a back face side of the flow-amount measuring unit; and a slope passage provided on a downstream side in a forward direction of the fluid in the second passage with respect to an outlet of the second passage. The slope passage has a first slope face on a first passage side with respect to the flow-amount measuring unit, the first slope face sloping from a second passage side to the first passage side with respect to the forward direction.

### TECHNICAL FIELD

The present invention relates to a thermal flowmeter.

### BACKGROUND ART

As a conventional thermal flowmeter, it has been known a flow-amount measuring apparatus including: a sub-passage disposed in a main passage in which fluid flows, the sub-passage taking in part of the fluid; a flow-amount measuring element disposed in the sub-passage, the flow-amount measuring element being formed with a heating resistor pattern; and a support having the flow-amount measuring element mounted thereon (for example, refer to claim 1 in PTL 1).

The conventional flow-amount measuring apparatus includes a first fluid passage portion and a second fluid passage portion. The first fluid passage portion has a face on which the flow-amount measuring element is mounted, and a passage forming face of the sub-passage. The second fluid passage portion has a face on the opposite side of the face on which the flow-amount measuring element is mounted, and a passage forming face of the sub-passage.

In the conventional flow-amount measuring apparatus, the passage forming face of the first fluid passage portion that is located on the upstream side of the flow of the fluid and is opposed to the flow-amount measuring element, has a slope face that leads the flow of the fluid to the flow measuring element. The slope face has at least two faces in different directions.

The configuration enables dust to rebound against the slope face provided on the opposed face on the upstream side with respect to the heating resistor pattern in the fluid passage portion on the heating resistor pattern side, so that the dust can be inhibited from flowing to the heating resistor pattern together with the flow of the fluid. Thus, there can be provided the flow-amount measuring apparatus capable of inhibiting the flow-amount measuring element including the heating resistor pattern, from being damaged or soiled, the flow-amount measuring apparatus having excellent dust resistance even in a unsteady flow field, such as a pulsating flow, the flow measuring apparatus having high reliability and hardly having a characteristic error (for example, refer to paragraph 0009 in PTL1).

### CITATION LIST

### Patent Literature

PTL 1: JP 2012-93203 A

### SUMMARY OF INVENTION

### Technical Problem

The conventional thermal flowmeter has a drawback that the increase of the fluid flowing in the counterflow direction in the first fluid passage portion due to the counterflow of the fluid during the pulsation of the fluid, causes a flow rate to be measured by the flow-amount measuring element to fall below the actual flow rate, resulting in an increase in measurement error.

The present invention has been made in consideration of the problem, and an object of the present invention is to provide a thermal flowmeter enabling a measurement error while fluid is pulsating, to fall below that of a conventional one.

### Solution to Problem

In order to achieve the object, the thermal flowmeter of the present invention includes: a sub-passage configured to take in part of fluid flowing in a main passage; and a flow-amount measuring unit disposed in the sub-passage. The sub-passage has: a first passage provided on a measurement face side of the flow-amount measuring unit; a second passage provided on a back face side of the flow-amount measuring unit; and a slope passage provided on a downstream side in a forward direction of the fluid in the second passage with respect to an outlet of the second passage. The slope passage has a first slope face on a first passage side with respect to the flow-amount measuring unit, the first slope face sloping from a second passage side to the first passage side with respect to the forward direction.

### Advantageous Effects of Invention

According to the thermal flowmeter of the present invention, even when the fluid counterflows while the fluid is pulsating, deviation can be made from the first passage side to the second passage side by the first slope face of the slope passage provided on the downstream side in the forward direction of the fluid in the second passage with respect to the outlet of the second passage. This arrangement enables the amount of flow of the fluid flowing in the counterflow direction in the first passage, to fall below that of a conventional one, to inhibit a flow rate to be measured from falling below the actual flow rate, so that a measurement error can fall below that of the conventional one.

### BRIEF DESCRIPTION OF DRAWINGS

FIG. 1 is a schematic view of an exemplary system having a thermal flowmeter according to a first embodiment of the present invention.

FIG. 2A is a front view of the thermal flowmeter according to the first embodiment of the present invention.

FIG. 2B is a left side view of the thermal flowmeter illustrated in FIG. 2A.

FIG. 2C is a rear view of the thermal flowmeter illustrated in FIG. 2A.

FIG. 2D is a right side view of the thermal flowmeter illustrated in FIG. 2A.

FIG. 3A is a front view of the thermal flowmeter, illustrated in FIG. 2A, having a front cover removed.

FIG. 3B is a rear view of the thermal flowmeter, illustrated in FIG. 2C, having a back cover removed.

FIG. 4 is a sectional view taken along line IV-IV of the thermal flowmeter illustrated in FIG. 2C.

FIG. 5 is a schematic developed view of a sub-passage of the thermal flowmeter illustrated in FIG. 4.

FIG. 6A is a front view of the front cover of the thermal flowmeter illustrated in FIG. 2A.

FIG. 6B is a rear view of the front cover of the thermal flowmeter illustrated in FIG. 6A.

FIG. 7A is a front view of the back cover of the thermal flowmeter illustrated in FIG. 2C.

FIG. 7B is a rear view of the back cover of the thermal flowmeter illustrated in FIG. 7A.

FIG. 8 is a graph illustrating an exemplary measured value of a conventional thermal flowmeter.

FIG. 9 is a graph illustrating an exemplary measured value of the thermal flowmeter according to the first embodiment of the present invention.

FIG. 10 is a schematic developed view of a sub-passage of a thermal flowmeter according to a second embodiment of the present invention.

FIG. 11 is a schematic developed view of a sub-passage of a thermal flowmeter according to a third embodiment of the present invention.

FIG. 12 is a schematic developed view of a sub-passage of a thermal flowmeter according to a fourth embodiment of the present invention.

### DESCRIPTION OF EMBODIMENTS

Embodiments of a thermal flowmeter of the present invention will be described below with reference to the drawings.

### First Embodiment

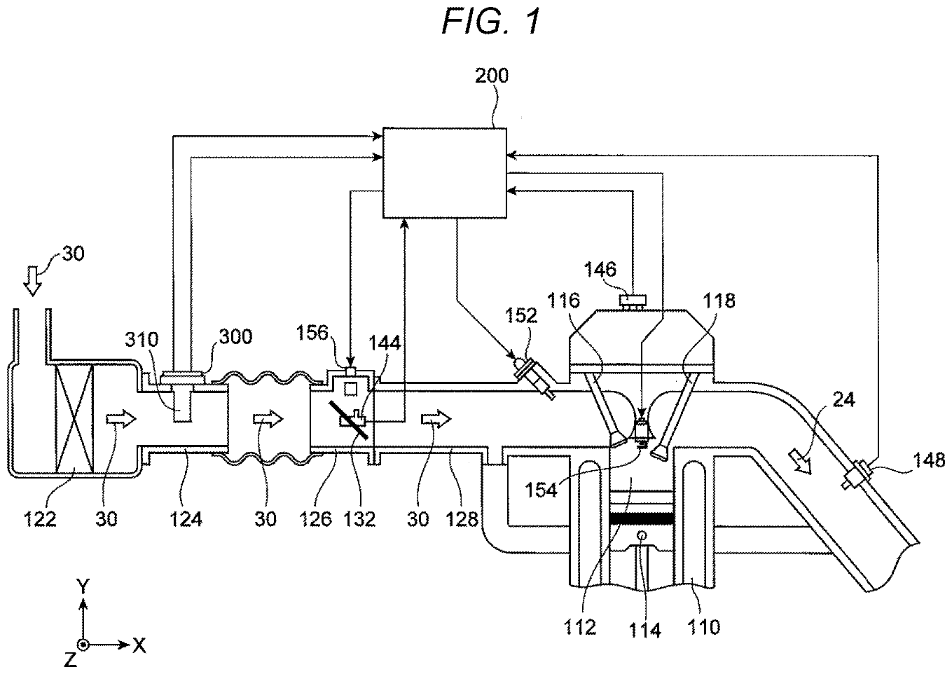

FIG. 1 is a schematic view of an exemplary electronic-fuel-injection internal-combustion-engine control system including a thermal flowmeter 300 according to a first embodiment of the present invention. In the system, on the basis of the operation of an internal combustion engine 110 including an engine cylinder 112 and an engine piston 114, inhale air is inhaled as gas to be measured 30 from an air cleaner 122 and then is guided to a combustion chamber of the engine cylinder 112 through an intake pipe that is an example of a main passage 124, a throttle body 126, and an intake manifold 128.

The amount of flow of the gas to be measured 30 that is the inhale air to be guided to the combustion chamber, is measured by the thermal flowmeter 300. A fuel injection valve 152 supplies fuel on the basis of the measured amount of flow, and then the fuel is guided together with the gas to be measured 30 that is the inhale air, in air-fuel mixture to the combustion chamber. Note that, in the present embodiment, the fuel injection valve 152 is provided at an intake port of the internal combustion engine. The fuel injected into the intake port mixes with the gas to be measured 30 that is the inhale air, to be the air-fuel mixture. Then, the air-fuel mixture is guided to the combustion chamber through an intake valve 116, and then the air-fuel mixture combusts to generate mechanical energy.

The thermal flowmeter 300 can be used not only for a scheme of injecting fuel into the intake port of the internal combustion engine illustrated in FIG. 1 but also for a scheme of directly injecting fuel into each combustion chamber. The basic concept of a method of measuring a control parameter, including a method of using the thermal flowmeter 300, and a method of controlling the internal combustion engine, including the supply of fuel and ignition timing, is substantially the same between both of the schemes. FIG. 1 illustrates the scheme of injecting fuel into the intake port as an exemplary representative for both of the schemes.

The fuel and the air guided to the combustion chamber that are in the mixture state of the fuel and the air, explosively combust due to spark ignition of an ignition plug 154, to generate the mechanical energy. The gas after the combustion is guided from an exhaust valve 118 to an exhaust pipe, and then is discharged as exhaust 24 from the exhaust pipe outside a vehicle. The amount of flow of the gas to be measured 30 that is the inhale air to be guided to the combustion chamber, is controlled by a throttle valve 132 in which the degree of opening varies on the basis of an operation of an accelerator pedal. Because the supply of the fuel is controlled on the basis of the amount of flow of the inhale air to be guided to the combustion chamber, an operator controls the degree of opening of the throttle valve 132 to control the amount of flow of the inhale air to be guided to the combustion chamber, so that the mechanical energy to be generated by the internal combustion engine, can be controlled.

The amount of flow and the temperature of the gas to be measured 30 that is the inhale air flowing in the main passage 124, taken in from the air cleaner 122, are measured by the thermal flowmeter 300. Electric signals indicating the measured amount of flow and temperature of the inhale air, are input from the thermal flowmeter 300 into a control device 200. An output of a throttle angle sensor 144 that measures the degree of opening of the throttle valve 132, is input into the control device 200, and, furthermore, outputs of a rotational angle sensor 146 are input into the control device 200 in order to measure the positions and the states of the engine piston 114, the intake valve 116, and the exhaust valve 118 in the internal combustion engine, and the rotational speed of the internal combustion engine. In order to measure the state of the mixture ratio between the amount of the fuel and the amount of the air from the state of the exhaust 24, an output of an oxygen sensor 148 is input into the control device 200.

The control device 200 computes the injection amount of the fuel and ignition timing, on the basis of the amount of flow, the humidity, and the temperature of the inhale air that are exemplary outputs of the thermal flowmeter 300, and, for example, the rotational speed of the internal combustion engine from the rotational angle sensor 146. On the basis of results of the computation, the amount of the fuel to be supplied from the fuel injection valve 152 and the ignition timing of ignition of the ignition plug 154, are controlled. The supply of the fuel and the ignition timing are in practice further controlled, on the basis of intake temperature measured by the thermal flowmeter 300, the state of a variation in throttle angle, the state of a variation in engine rotational speed, and the state of an air-fuel ratio measured by the oxygen sensor 148. The control device 200 further controls the amount of the air that bypasses the throttle valve 132, with an idle air control valve 156 in the idling operation state of the internal combustion engine, to control the rotational speed of the internal combustion engine in the idling operation state.

The supply of the fuel and the ignition timing that are main controlled variables in the internal combustion engine, are both computed with the outputs of the thermal flowmeter 300 as main parameters. Therefore, improvement in measurement precision, inhibition of aging, and improvement in reliability of the thermal flowmeter 300 are important to improvement in control precision and ensuring of reliability of the vehicle. Particularly, in recent years, low fuel consumption of vehicles considerably grows in demand and exhaust gas cleanups considerably grow in demand. It is extremely important to improve the measurement precision for the amount of flow of the gas to be measured 30 that is the inhale air to be measured by the thermal flowmeter 300, in order to meet these demands.

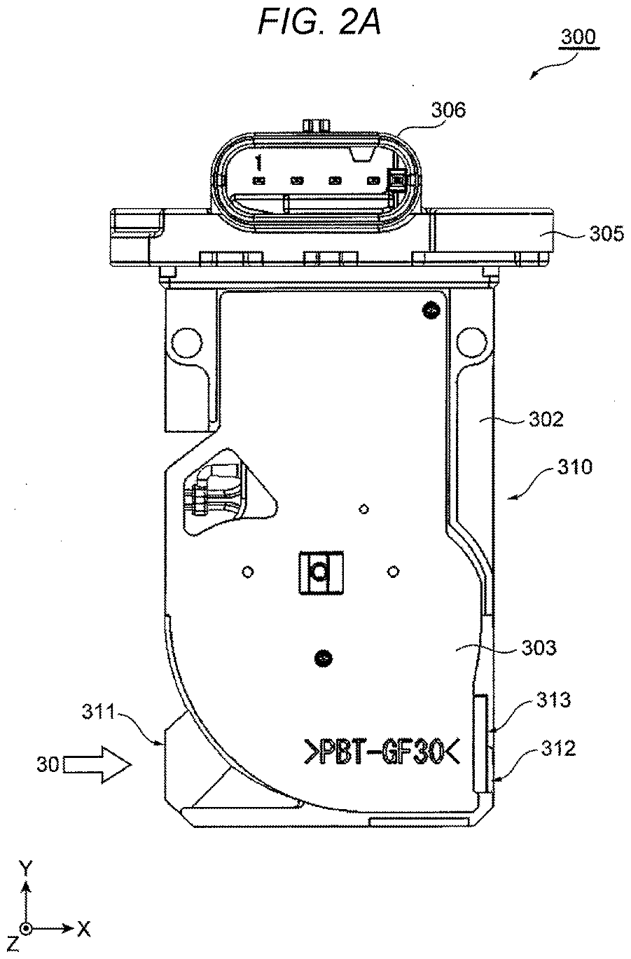

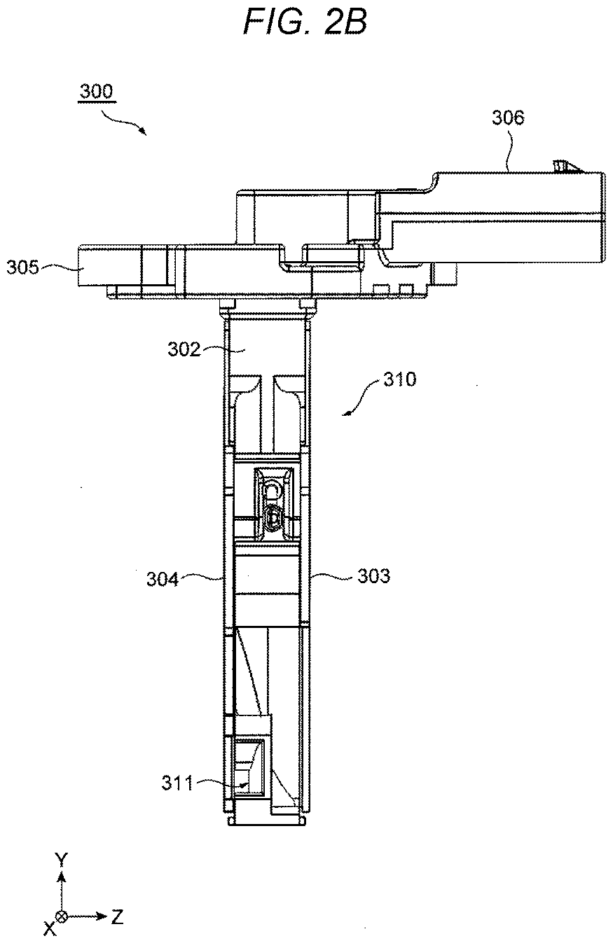

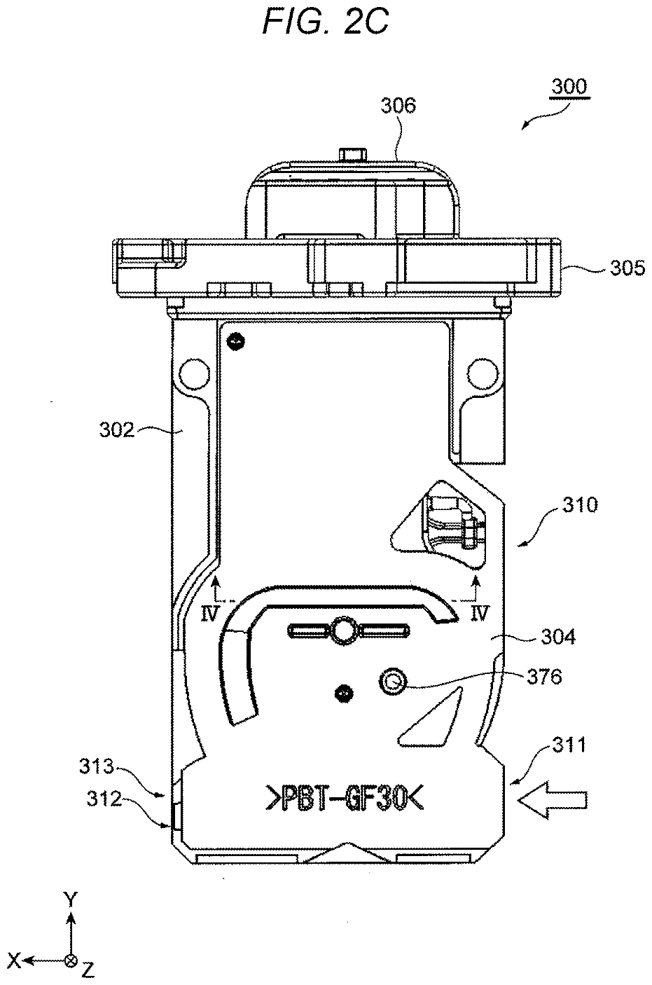

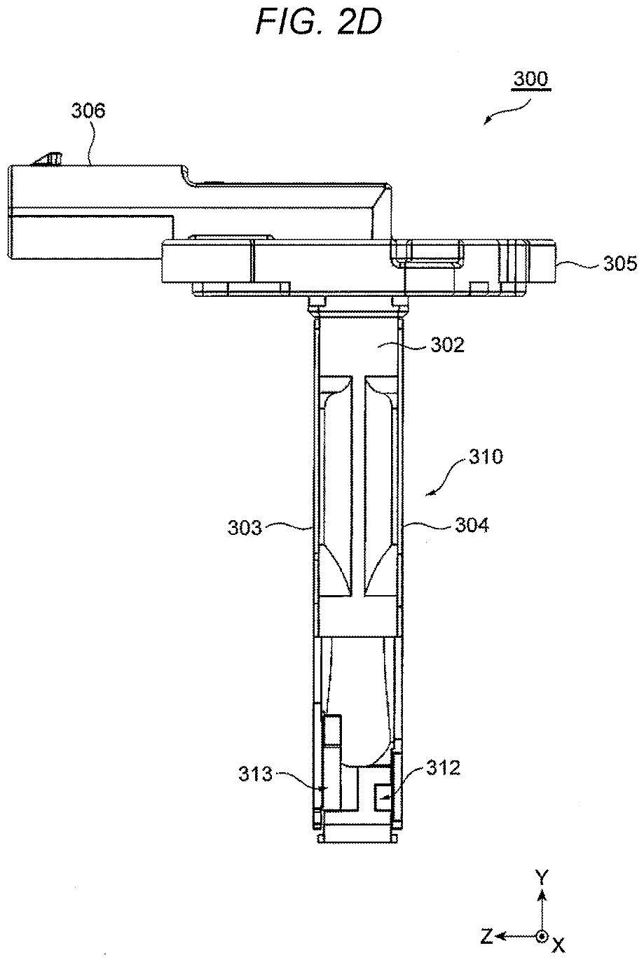

FIG. 2A is a front view of the thermal flowmeter 300 according to the present embodiment. FIGS. 2B, 2C, and 2D are a left side view, a rear view, and a right side view of the thermal flowmeter illustrated in FIG. 2A, respectively.

The thermal flowmeter 300 has a casing 310 including a housing 302, a front cover 303, and a back cover 304. The front cover 303 and the back cover 304 each formed in a thin plate shape, have a wide planar cooling face. Thus, the thermal flowmeter 300 has a configuration of reducing air resistance and further allowing the casing 310 to be easily cooled by the gas to be measured flowing in the main passage 124.

The casing 310 having, for example, a substantially cuboid flat shape is disposed in the main passage 124, the casing 310 being inserted in the intake pipe, as illustrated in FIG. 1. Although the details thereof will be described later, the casing 310 demarcates a sub-passage that takes in part of the gas to be measured 30 that is fluid flowing in the main passage 124.

Note that, in some cases, each part of the thermal flowmeter 300 will be described with an XYZ Cartesian coordinates system having: an X axis direction in the length direction of the casing 310 substantially parallel to the flow of the gas to be measured 30 in the main passage 124; a Y axis direction in the height direction of the casing 310 substantially parallel to the radial direction of the main passage 124, the height direction being perpendicular to the length direction; and a Z axis direction in the thickness direction of the casing 310 perpendicular to the length direction and the height direction.

Although the casing 310 has an elongate shape along an axis from the outer wall of the main passage 124 to the center, as illustrated in FIGS. 2B and 2D, the casing 310 has a flat shape thin in thickness. That is the casing 310 of the thermal flowmeter 300 is thin in thickness along the side faces, and the front face has a substantially rectangular shape. This arrangement enables the thermal flowmeter 300 to reduce fluid resistance for the gas to be measured 30 and include the sub-passage having a sufficient length.

The base end portion of the housing 302 is provided with a flange 305 for securing the thermal flowmeter 300 to the intake pipe and a connector 306 that is an external connecting portion exposed outside the intake pipe in order to electrically connect with external equipment. The flange 305 is secured to the intake pipe, so that the housing 302 is supported in a cantilever state.

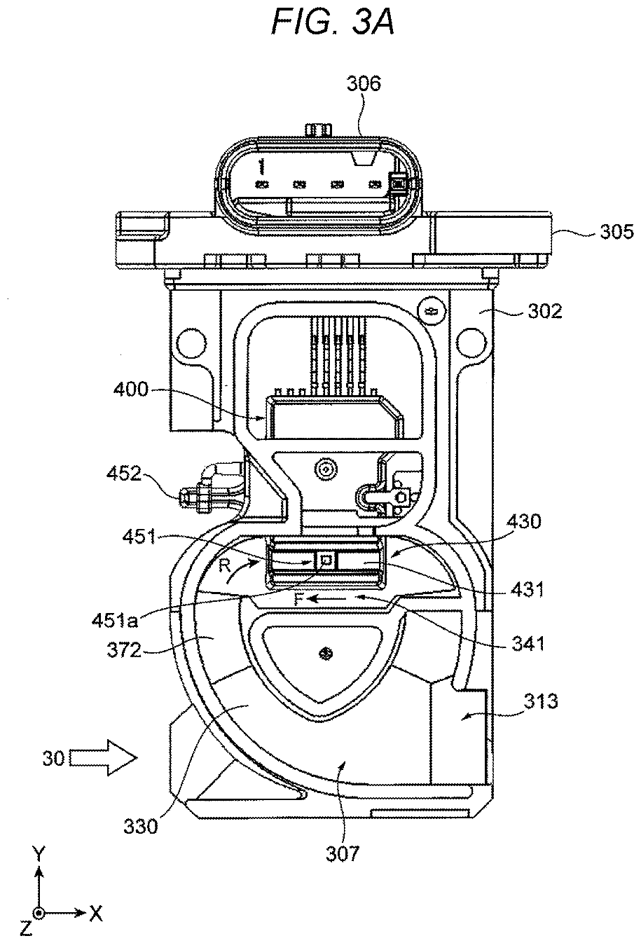

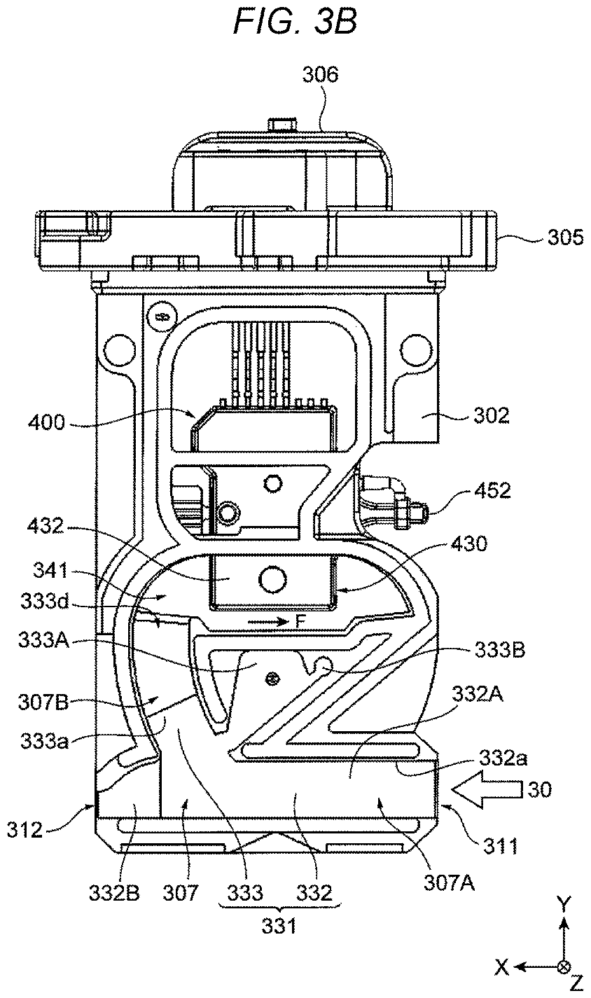

FIG. 3A is a front view of the thermal flowmeter 300, illustrated in FIG. 2A, having the front cover 303 removed. FIG. 3B is a rear view of the thermal flowmeter 300, illustrated in FIG. 2C, having the back cover 304 removed.

At a position on the upstream side in a mainstream direction on the front end side of the housing 302, an inlet 311 is provided for taking the part of the gas to be measured 30, such as the inhale air, that is the fluid flowing in the main passage 124, into the sub-passage 307. In this manner, the inlet 311 for taking the gas to be measured 30 flowing in the main passage 124, into the sub-passage 307, is provided on the front end side of the casing 310 extending from the flange 305 to the center in the radial direction of the main passage 124.

This arrangement enables the sub-passage 307 to take in the air apart from the inner wall face of the main passage 124. Thus, there is hardly influence from the temperature of the inner wall face of the main passage 124, so that the measurement precision for the amount of flow or the temperature of the gas can be inhibited from decreasing. The fluid resistance is large in the neighborhood of the inner wall face of the main passage 124, and thus the flow rate is lower than the average flow rate in the main passage 124. Because the thermal flowmeter 300 of the present embodiment, has the inlet 311 provided at the front end portion of the thin elongate casing 310 extending from the flange 305 to the center of the main passage 124, the sub-passage 307 can take in the gas having a high flow rate in a center portion of the main passage 124.

At positions on the downstream side in the mainstream direction on the front end side of the housing 302, a first outlet 312 and a second outlet 313 are provided for returning the gas to measured 30 from the sub-passage 307 to the main passage 124. The first outlet 312 and the second outlet 313 are disposed side by side in the thickness direction (Z axis direction) of the housing 302, as illustrated in FIG. 2D. In this manner, the first outlet 312 and the second outlet 313 that are discharge outlets of the sub-passage 307, are provided at the front end portion of the casing 310, so that the gas flowing in the sub-passage 307 can be returned in the neighborhood of the center portion of the main passage 124 in which the flow rate is high.

A circuit package 400 including, for example, a flow-amount measuring unit 451 for measuring the amount of flow of the gas to be measured 30 flowing in the main passage 124 and a temperature measuring unit 452 for measuring the temperature of the gas to be measured 30 flowing in the main passage 124, is integrally molded and formed inside the housing 302. The housing 302 is formed with sub-passage grooves 330 and 331 for demarcating the sub-passage 307. In the present embodiment, the sub-passage grooves 330 and 331 are provided having recesses on the front face and the back face of the housing 302, respectively.

Thus, attachment of the front cover 303 and the back cover 304 onto the front face and the back face of the housing 302, allows the front cover 303 and the back cover 304 to cover the sub-passage grooves 330 and 331 of the housing 302, so that the casing 310 demarcating the sub-passage 307 can be achieved. For the housing 302 having the configuration, for example, molding of the housing 302 and molding of the front sub-passage groove 330 and the back sub-passage groove 331 can be performed collectively with a mold disposed on both faces of the housing 302, in a resin mold process in which the housing 302 is molded.

The sub-passage groove 331 provided on the back side of the housing 302, has a straight groove portion 332 for demarcating a straight passage 307A in part of the sub-passage 307 and a branch groove portion 333 for demarcating a branch passage 307B in part of the sub-passage 307, as illustrated in FIG. 3B.

The straight groove portion 332 extends straight in the mainstream direction (X axis positive direction) of the gas to be measured 30, at the front end portion of the housing 302, and has one end in communication with the inlet 311 of the housing 302 and the other end in communication with the first outlet 312 of the housing 302. The straight groove portion 332 has a straight portion 332A extending from the inlet 311, retaining a substantially constant sectional shape, and a taper portion 332B having a groove width gradually tapering in accordance with a transition from the straight portion 332A to the first outlet 312. The first outlet 312 is the discharge outlet that discharges part of the fluid flowing in the straight passage 307A of the sub-passage 307, namely, part of the gas to be measured 30. The provision of the first outlet 312 allows foreign substances, such as dust, to be discharged from the sub-passage 307, so that the total volume of foreign substances to be taken into the branch passage 307B of the sub-passage 307 can be reduced and the measurement performance of the flow-amount measuring unit 451 can be prevented from deteriorating.

The branch groove portion 333 branching from the straight portion 332A of the straight groove portion 332, leads to the base end side of the housing 302 in a curve and is in communication with a flow channel for measurement 341 provided at a center portion in the height direction (Y axis direction) that is the longitudinal direction of the housing 302. The branch groove portion 333 has an upstream end in communication with a side wall face 332a located on the base end side of the housing 302 from paired side wall faces included in the straight groove portion 332, and a bottom wall face 333a continuing flush with the bottom wall face of the straight portion 332A of the straight groove portion 332, with no difference in level.

A housing groove portion 333A is provided on the side wall face on the inside of the curve of the branch groove portion 333. The housing groove portion 333A has a recess portion 333B. The recess portion 333B takes in water invading the housing groove portion 333A, and discharges the water, outside the casing 310, from a drain hole 376 pierced at a position of the back cover 304 opposed to the recess portion 333B, as illustrated in FIG. 2C.

The flow channel for measurement 341 is formed penetrating in the thickness direction from the front side to the back side of the housing 302. A flow-channel exposed portion 430 of the circuit package 400 is disposed protruding in the flow channel for measurement 341. The branch groove portion 333 is in communication with the flow channel for measurement 341, on the upstream side of the sub-passage 307 with respect to the flow-channel exposed portion 430 of the circuit package 400. From the straight groove portion 332 to the flow channel for measurement 341 in the height direction (Y axis direction) of the housing 302, the branch groove portion 333 extends in a curve in the opposite direction (X axis negative direction) to the mainstream direction of the gas to be measured 30 in the main passage 124.

The branch passage 307B of the sub-passage 307, demarcated by the branch groove portion 333, leads from the front end side of the housing 302 to the base end side that is the flange 305 side, drawing a curve. The flow channel for measurement 341 is provided at a position at which the branch passage 307B is closest to the flange 305. In the flow channel for measurement 341, the gas to be measured 30 flowing in the sub-passage 307 flows in the opposite direction (X axis negative direction) to the mainstream direction of the main passage 124.

In the thermal flowmeter 300 of the present embodiment, the branch groove portion 333 has a three-dimensional shape in which a groove depth gradually deepens, to the flow channel for measurement 341, in the thickness direction (Z axis direction) of the housing 302. In the thermal flowmeter 300 of the present embodiment, the branch groove portion 333 has a steep slope portion 333d rapidly deepening on the near side of the flow channel for measurement 341.

The steep slope portion 333d has a function of passing the gas to be measured 30 that is gas, to the front face 431 side on which a measurement face 451a of the flow-amount measuring unit 451 is provided, from a front face 431 and a back face 432 that the flow-channel exposed portion 430 of the circuit package 400 has in the flow channel for measurement 341. Then, the foreign substances, such as the dust, included in the gas to be measured 30 pass onto the back face 432 side of the flow-channel exposed portion 430 of the circuit package 400 that is the back face side of the flow-amount measuring unit 451, so that the soiling resistance of the measurement face 451a of the flow-amount measuring unit 451 improves.

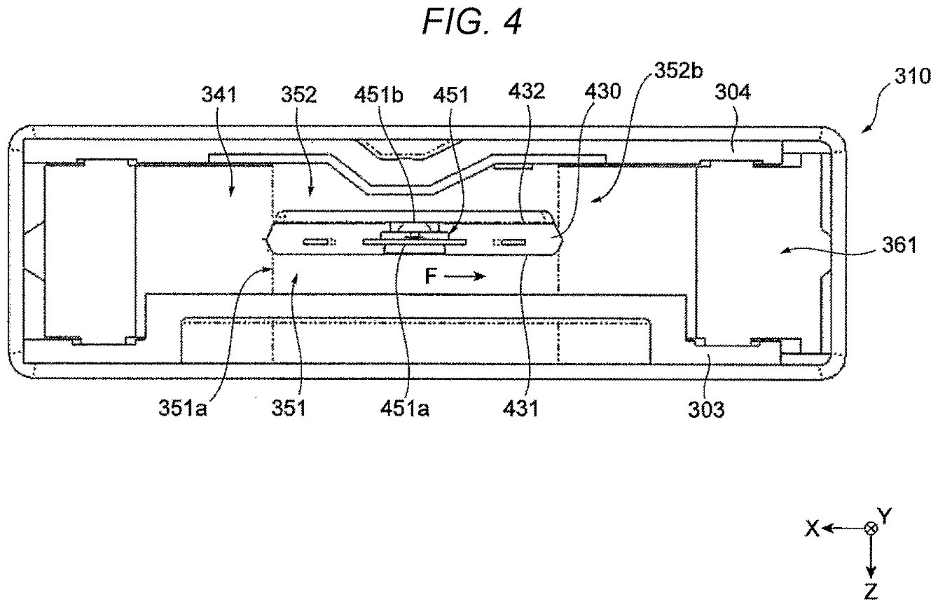

In more detail, part of the air small in mass moves along the steep slope portion 333d, and then flows in a first passage 351 (refer to FIG. 4) on the front face 431 side of the flow-channel exposed portion 430 of the circuit package 400, namely, on the measurement face 451a side of the flow-amount measuring unit 451, in the flow channel for measurement 341. Meanwhile, the foreign substances large in mass have difficulty in changing paths sharp due to centrifugal force along the curve of the branch passage 307B of the sub-passage 307. Thus, because the foreign substances large in mass cannot flow along the steep slope portion 333d, the foreign substances flow on the back face 432 side of the flow-channel exposed portion 430 of the circuit package 400, namely, in a second passage 352 (refer to FIG. 4) on the back face 451b side of the flow-amount measuring unit 451.

The sub-passage groove 330 provided on the front side of the housing 302 illustrated in FIG. 3A, demarcates the portion on the downstream side of the branch passage 307B of the sub-passage 307. The portion on the downstream side of the branch passage 307B, demarcated by the sub-passage groove 330, has one end in communication with the portion on the upstream side of the branch passage 307B on the back side of the housing 302 through the flow channel for measurement 341, and the other end in communication with the second outlet 313 formed on the front end of the housing 302.

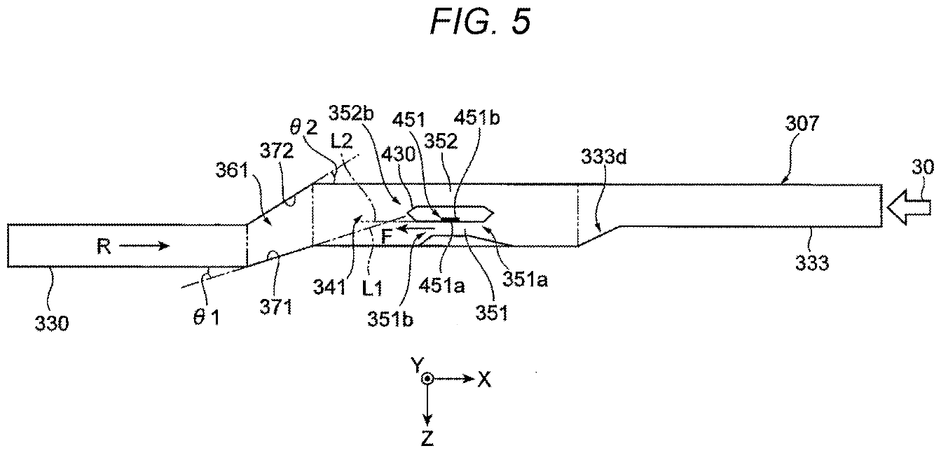

In the thermal flowmeter 300 of the present embodiment, the sub-passage groove 330 demarcating the portion on the downstream side of the branch passage 307B of the sub-passage 307, has a second slope face 372 demarcating a slope passage 361 to be described later (refer to FIG. 5), on the downstream side in the forward direction F of the gas to be measured 30 in the flow channel for measurement 341.

The sub-passage groove 330 provided on the front side of the housing 302, gradually leads to the downstream side in the mainstream direction, in a curve, in accordance with a transition to the front end side of the housing 302, the sub-passage groove 330 extending straight to the downstream side in the mainstream direction of the gas to be measured 30, at the front end portion of the housing 302, the sub-passage groove 330 having a shape in which a groove width gradually tapers to the second outlet 313. The gas to be measured 30 and the foreign substances that have passed through the flow channel for measurement 341, flow through the portion on the downstream side of the branch passage 307B of the sub-passage 307 demarcated by the sub-passage groove 330 provided on the front side of the housing 302. Then, the gas to be measured 30 and the foreign substances are discharged from the second outlet 313, and return to the main passage 124.

The flow-channel exposed portion 430 of the circuit package 400, protrudes from a wall face of the branch groove portion 333 of the sub-passage groove 331 demarcating the flow channel for measurement 341, into the flow channel for measurement 341, toward the front end side of the housing 302 in the height direction (Y axis direction) of the housing 302. The flow-channel exposed portion 430 having a thickness in the thickness direction (Z axis direction) of the housing 302, is formed in a rectangular plate shape in the stream direction of the gas to be measured 30 flowing in the flow channel for measurement 341. The flow-channel exposed portion 430 functions as a supporting portion that disposes the flow-amount measuring unit 451 in the sub-passage 307, supporting the flow-amount measuring unit 451.

FIG. 4 is a sectional view taken along line IV-IV of the thermal flowmeter 300 illustrated in FIG. 2C.

The sub-passage 307 has the first passage 351 provided on the measurement face 451a side of the flow-amount measuring unit 451 and the second passage 352 provided on the back face 451b side of the flow-amount measuring unit 451, in the flow channel for measurement 341. The sub-passage 307 has the slope passage 361 provided on the downstream side in the forward direction F of the fluid in the second passage 352 with respect to an outlet 352b of the second passage 352, namely, on the downstream side in the forward direction F of the gas to be measured 30 in the first passage 351.

The air that is the gas to be measured 30, flows in the forward direction F of the gas to be measured 30 in the first passage 351 of the flow channel for measurement 341. In this case, heat transfer is performed with the gas to be measured 30 through the measurement face 451a that is a heat transfer face, provided at the flow-amount measuring unit 451, and then the amount of flow is measured. Note that this measurement principle for the amount of flow, can adopt a general measurement principle for a thermal flowmeter. As long as the amount of flow of the gas to be measured 30 flowing in the main passage 124 can be measured on the basis of a measured value measured by the flow-amount measuring unit 451, like the thermal flowmeter 300 of the present embodiment, the configuration of the flow-amount measuring unit 451 is not particularly limited.

The thermal flowmeter 300 of the present embodiment, has the slope passage 361 characterized, the slope passage 361 being provided on the downstream side in the forward direction F of the gas to be measured 30 in the second passage 352 with respect to the outlet 352b of the second passage 352 provided on the back face 451b side of the flow-amount measuring unit 451 in the flow channel for measurement 341 of the sub-passage 307. The slope passage 361 has a first slope face 371 (refer to FIG. 5) on the first passage 351 side with respect to the flow-amount measuring unit 451, the first slope face 371 sloping from the second passage 352 side to the first passage 351 side with respect to the forward direction F of the gas to be measured 30.

Note that, as described above, although the thermal flowmeter 300 of the present embodiment includes the flat casing 310 disposed in the main passage 124, the casing 310 demarcating the sub-passage 307, the measurement face 451a of the flow-amount measuring unit 451 disposed in the sub-passage 307, is substantially perpendicular to the thickness direction (Z axis direction) of the casing 310.

In the thermal flowmeter 300 of the present embodiment, the sub-passage 307 has the straight passage 307A that takes in the part of the gas to be measured 30 that is the fluid flowing in the main passage 124, as described above (refer to FIG. 3B). The sub-passage 307 has the first outlet 312 that is the discharge outlet that discharges the part of the gas to be measured 30 that is the fluid flowing in the straight passage 307A, and the branch passage 307B branching from the straight passage 307A, on the upstream side in the forward direction of the fluid flowing in the straight passage 307A with respect to the first outlet 312. All of the first passage 351, the second passage 352, and the slope passage 361 described above are provided in the branch passage 307B.

FIG. 5 is a schematic developed view of the sub-passage 307 of the thermal flowmeter 300 illustrated in FIG. 4. FIG. 5 illustrates a section in the thickness direction (Z axis direction) of the casing 310 at portions of the sub-passage 307 ahead of and behind the flow channel for measurement 341, developed in parallel to the thickness direction (Z axis direction) and the length direction (X axis direction) of the casing 310.

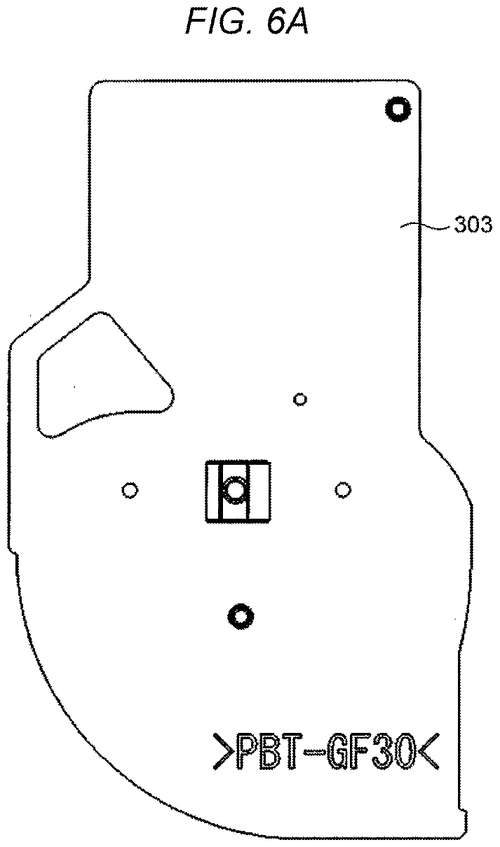

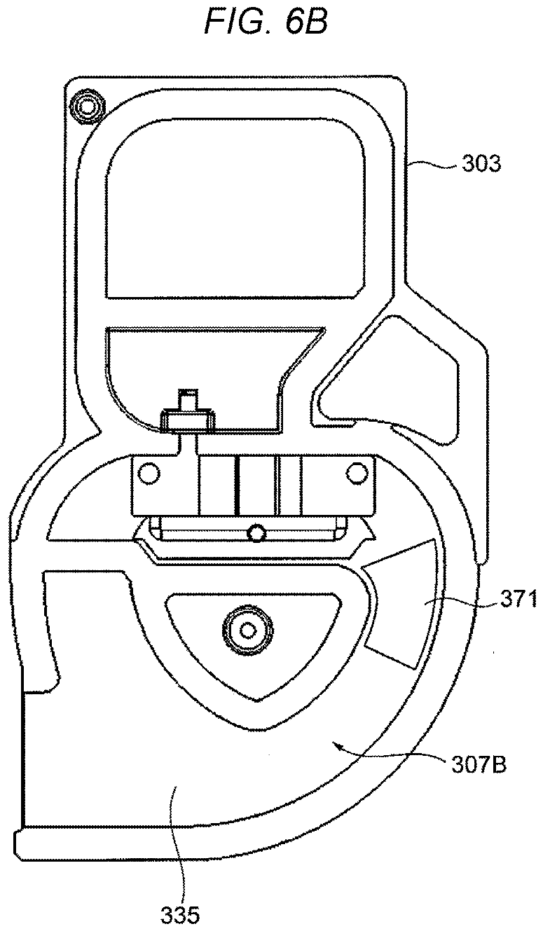

As described above, the thermal flowmeter 300 of the present embodiment, has the sub-passage 307 that takes in the part of the gas to be measured 30 that is the fluid flowing in the main passage 124, and the flow-amount measuring unit 451 disposed in the sub-passage 307. The sub-passage 307 has the first passage 351 provided on the measurement face 451a side of the flow-amount measuring unit 451, the second passage 352 provided on the back face 451b side of the flow-amount measuring unit 451, and the slope passage 361 provided on the downstream side in the forward direction F of the gas to be measured 30 in the second passage 352 with respect to the outlet 352b of the second passage 352. The slope passage 361 has the first slope face 371 on the first passage 351 side with respect to the flow-amount measuring unit 451, the first slope face 371 sloping from the second passage 352 side to the first passage 351 side with respect to the forward direction F of the gas to be measured 30. The first slope face 371 is provided on the back face side of the front cover 303, for example, as illustrated in FIG. 6B.

Furthermore, in the example illustrated in FIG. 5, the slope passage 361 has the second slope face 372 opposed to the first slope face 371 in a direction (Z axis direction) perpendicular to the measurement face 451a of the flow-amount measuring unit 451. Similarly to the first slope face 371, the second slope face 372 slopes from the second passage 352 side to the first passage 351 side with respect to the forward direction F of the gas to be measured 30. The second slope face 372 is provided on the bottom portion of the sub-passage groove 330 of the housing 302, as illustrated in FIG. 3A.

In the example illustrated in FIG. 5, the slope angle θ2 of the second slope face 372 with respect to the forward direction F of the gas to be measured 30, is larger than the slope angle θ1 of the first slope face 371 with respect to the forward direction F of the gas to be measured 30. More specifically, the difference in angle between the slope angle θ1 of the first slope face 371 and the slope angle θ2 of the second slope face 372, can range from 3° to 15°, for example.

In the example illustrated in FIG. 5, the sub-passage 307 has a portion on the downstream side in the forward direction F of the gas to be measured 30 with respect to the slope passage 361, the portion being provided on the first passage 351 side with respect to the second passage 352 in the direction (Z axis direction) perpendicular to the measurement face 451a of the flow-amount measuring unit 451.

In the example illustrated in FIG. 5, the sub-passage 307 has the extended line L1 of the first slope face 371 and the extended line L2 of the measurement face 451a intersecting on the downstream side in the forward direction F of the gas to be measured 30 with respect to the measurement face 451a, on the section perpendicular to the measurement face 451a of the flow-amount measuring unit 451, in parallel to the forward direction F of the gas to be measured 30. In the forward direction F of the gas to be measured 30, the extended line L1 of the first slope face 371 and the extended line L2 of the measurement face 451a may intersect on the downstream side with respect to the end portion on the downstream side of the flow-channel exposed portion 430 of the circuit package 400, the flow-channel exposed portion 430 functioning as the supporting portion for the flow-amount measuring unit 451.

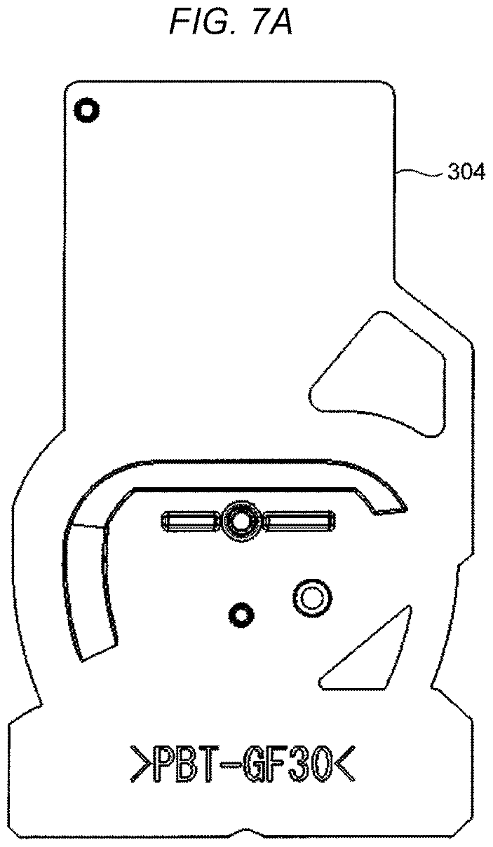

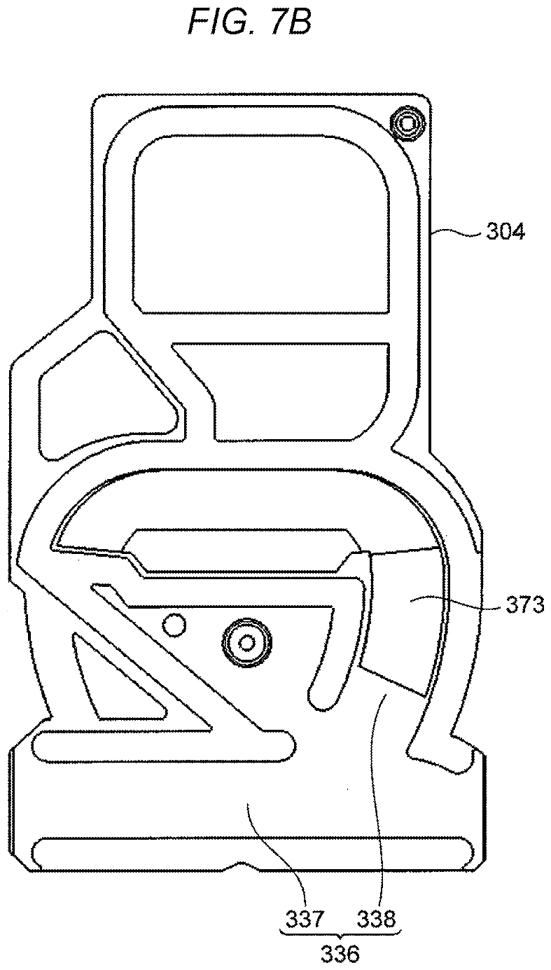

FIGS. 6A and 6B are a front view and a rear view of the front cover 303 of the thermal flowmeter 300 illustrated in FIG. 2A, respectively. FIGS. 7A and 7B are a front view and a rear view of the back cover 304 of the thermal flowmeter 300 illustrated in FIG. 2C, respectively.

As described above, the front cover 303 and the back cover 304 are constituent members of the casing 310 that demarcates the sub-passage 307, and have sub-passage grooves 335 and 336 for demarcating the sub-passage 307, on the back face sides opposed to the housing 302, respectively. The sub-passage groove 335 of the front cover 303 demarcates the flow channel for measurement 341 of the branch passage 307B of the sub-passage 307 and the portion on the downstream side thereof, together with the sub-passage groove 330 the housing 302 illustrated in FIG. 3A. The bottom portion of the sub-passage groove 335 of the front cover 303 is provided with the first slope face 371 that demarcates the slope passage 361 illustrated in FIG. 5.

The sub-passage groove 336 of the back cover 304 has a straight groove portion 337 for demarcating the straight passage 307A in part of the sub-passage 307 and a branch groove portion 338 for demarcating the branch passage 307B in part of the sub-passage 307, similarly to the sub-passage groove 331 provided on the back side of the housing 302 illustrated in FIG. 3B.

The function of the thermal flowmeter 300 of the present embodiment, will be described below.

In the internal-combustion-engine control system illustrated in FIG. 1, depending on conditions, it is likely that the inhale air as the gas to be measured 30 flowing in the main passage 124 pulsates and the gas to be measured 30 counterflows from the downstream side to the upstream side in the mainstream direction.

Here, the thermal flowmeter 300 of the present embodiment includes the sub-passage 307 that takes in part of the fluid flowing in the main passage 124 as described above. Thus, when the gas to be measured 30 flowing in the main passage 124 counterflows, as illustrated in FIG. 5, it is likely that the gas to be measured 30 flowing in the flow channel for measurement 341 of the sub-passage 307 flows in the counterflow direction R opposite to the forward direction F, from the downstream side to the upstream side in the forward direction F of the flow channel for measurement 341.

The thermal flowmeter 300 of the present embodiment, includes the flow-amount measuring unit 451 disposed in the flow channel for measurement 341 of the sub-passage 307, as described above. The sub-passage 307 has the first passage 351 provided on the measurement face 451a of the flow-amount measuring unit 451 and the second passage 352 provided on the back face side of the flow-amount measuring unit 451. Thus, when the gas to be measured 30 counterflowing in the flow channel for measurement 341 flows in the first passage 351 in large amounts, the average value in flow rate to be measured by the flow-amount measuring unit 451 falls below the actual flow rate, thus there is a drawback that a measurement error increases.

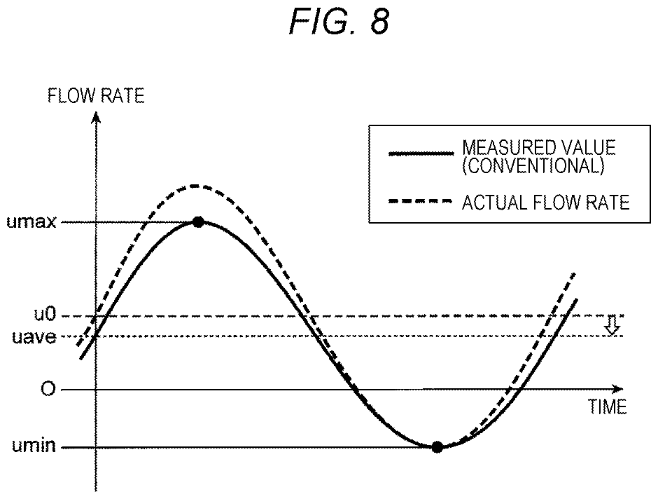

FIG. 8 is a graph illustrating an exemplary measured value of a conventional thermal flowmeter having no slope passage 361. In FIG. 8, the horizontal axis represents time and the vertical axis represents flow rate. In FIG. 8, the variation of the measured value in flow rate by the conventional thermal flowmeter is indicated with a solid line, and the variation of the actual flow rate of the gas to be measured 30 is indicated with a broken line.

An increase in straightness due to the inertial effect of fluid while the gas to be measured 30 is pulsating, is larger than that in a stationary state in which no pulsation occurs. Thus, the gas to be measured 30 in the forward direction, taken in from the inlet 311 to the sub-passage 307 illustrated in FIG. 3B, passes through the straight passage 307A but does not branch into the branch passage 307B, so that the amount of flow to be discharged from the first outlet 312 increases. As a result, the amount of flow of the gas to be measured 30 branching from the straight passage 307A to the branch passage 307B of the sub-passage 307, decreases, and then the amount of flow of the gas to be measured 30 in the forward direction F, flowing into the flow channel for measurement 341, decreases. Thus, as illustrated in FIG. 8, the maximum value umax of the measured value in flow rate by the thermal flowmeter, falls below the maximum value of the actual flow rate of the gas to be measured 30.

Meanwhile, all the gas to be measured 30 in the counterflow direction, taken from the second outlet 313 into in the sub-passage 307 illustrated in FIG. 3A, flows into the flow channel for measurement 341 without being discharged in midstream. As a result, while the gas to be measured 30 is counterflowing, the amount of flow of the gas to be measured 30 in the counterflow direction R, flowing into the flow channel for measurement 341, does not decrease. As illustrated in FIG. 8, the minimum value umin of the measured value in flow rate by the thermal flowmeter, substantially equals to the actual flow rate of the gas to be measured 30. In this case, the average value uave of the measured value of the conventional thermal flowmeter having no slope passage 361, falls below the average value u0 of the actual flow rate of the gas to be measured 30, and thus a negative measurement error occurs.

In contrast to this, as illustrated in FIG. 5, the thermal flowmeter 300 of the present embodiment has the slope passage 361 provided on the downstream side in the forward direction F of the gas to be measured 30 that is the fluid in the second passage 352 with respect to the outlet 352b of the second passage 352 provided on the back face side of the flow-amount measuring unit 451. The slope passage 361 has the first slope face 371 on the first passage 351 side with respect to the flow-amount measuring unit 451, the first slope face 371 sloping from the second passage 352 side to the first passage 351 side with respect to the forward direction F of the gas to be measured 30.

Thus, the gas to be measured 30 flowing in the counterflow direction R from the downstream side to the upstream side in the forward direction F of the gas to be measured 30 with respect to the slope passage 361, flows along the first slope face 371 of the slope passage 361 and deviates from the first passage 351 side to the second passage 352 side. This arrangement can increase the amount of flow of the gas to be measured 30 flowing in the counterflow direction R in the second passage 352, to decrease the amount of flow of the gas to be measured 30 flowing in the counterflow direction R in the first passage 351, in comparison with the conventional thermal flowmeter having no slope passage 361.

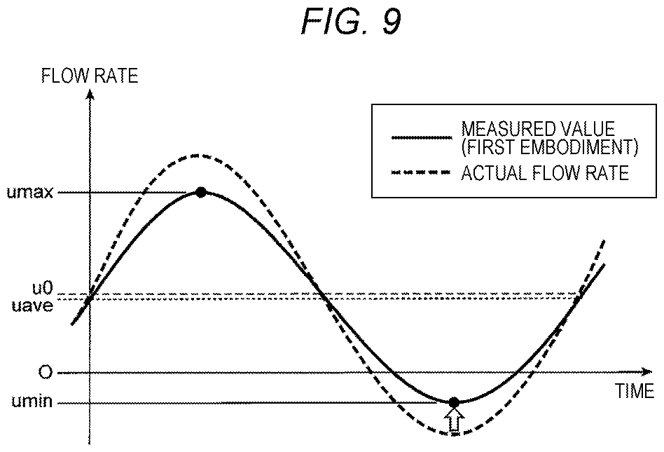

FIG. 9 is a graph illustrating an exemplary measured value of the thermal flowmeter 300 of the present embodiment. In FIG. 9, the horizontal axis represents time and the vertical axis represents flow rate. In FIG. 9, the variation of the measured value in flow rate by the thermal flowmeter 300 of the present embodiment is indicated with a solid line, and the variation of the actual flow rate of the gas to be measured 30 is indicated with a broken line.

As described above, the thermal flowmeter 300 of the present embodiment, can increase the amount of flow of the gas to be measured 30 flowing in the counterflow direction R in the second passage 352, to decrease the amount of flow of the gas to be measured 30 flowing in the counterflow direction R in the first passage 351, in comparison with the conventional thermal flowmeter having no slope passage 361. Thus, as illustrated in FIG. 9, the absolute value of the minimum value umin of the measured value in flow rate by the thermal flowmeter 300, falls below the absolute value of the actual flow rate of the gas to be measured 30. This arrangement increases the average value uave of the measured value and decreases the negative measurement error between the average value uave of the measured value and the average value u0 of the actual flow rate of the gas to be measured 30, in the thermal flowmeter 300 of the present embodiment. As a result, the time average value uave in flow rate to be measured by the thermal flowmeter 300 while the gas to be measured 30 is pulsating, can substantially equal the average value u0 of the actual flow rate of the gas to be measured 30, so that the measurement error of the thermal flowmeter 300 can fall below that of the conventional one.

In the thermal flowmeter 300 of the present embodiment, the slope passage 361 has the second slope face 372 opposed to the first slope face 371 in the direction (Z axis direction) perpendicular to the measurement face 451a of the flow-amount measuring unit 451. The second slope face 372 slopes from the second passage 352 side to the first passage 351 side with respect to the forward direction F of the gas to be measured 30. This arrangement inhibits an eddy from occurring in the flow in the counterflow direction R of the gas to be measured 30 deviating due to the first slope face 371 of the slope passage 361, so that the amount of flow of the gas to be measured 30 flowing in the counterflow direction R in the second passage 352, can increase.

In the thermal flowmeter 300 of the present embodiment, the slope angle θ2 of the second slope face 372 with respect to the forward direction F of the gas to be measured 30 is larger than the slope angle θ1 of the first slope face 371 with respect to the forward direction F. This arrangement effectively inhibits an eddy from occurring in the flow of the gas to be measured 30 deviating due to the first slope face 371 of the slope passage 361, so that the amount of flow of the gas to be measured 30 flowing in the counterflow direction R in the second passage 352, can increase.

The difference in angle between the slope angle θ1 of the first slope face 371 and the slope angle θ2 of the second slope face 372, for example, in a range of from 3° to 15°, can inhibit an eddy that easily occurs in the pipe that has expanded radially. That is rendering the angle at which the slope passage 361 expands radially, gentle, rectifies the flow in the counterflow R of the gas to be measured 30 in the flow channel for measurement 341, so that the flow can stabilized in the counterflow direction R of the gas to be measured 30 in the first passage 351 and the second passage 352.

In the thermal flowmeter 300 of the present embodiment, as illustrated in FIG. 5, the sub-passage 307 has the portion on the downstream side in the forward direction F of the gas to be measured 30 with respect to the slope passage 361, the portion being provided on the first passage 351 side with respect to the second passage 352 in the direction (Z axis direction) perpendicular to the measurement face 451a of the flow-amount measuring unit 451. Thus, in a case where the slope passage 361 has no first slope face 371, the flow in the counterflow direction R of the gas to be measured 30 easily flows into the first passage 351. However, the slope passage 361 having the first slope face 371 allows the flow in the counterflow direction R of the gas to be measured 30, to deviate from the first passage 351 side to the second passage 352 side, so that the flow rate of the fluid flowing in the counterflow direction R in the first passage 351, can be reduced.

In the thermal flowmeter 300 of the present embodiment, as illustrated in FIG. 5, the sub-passage 307 has the extended line L1 of the first slope face 371 and the extended line L2 of the measurement face 451a intersecting on the downstream side in the forward direction F of the gas to be measured 30 with respect to the measurement face 451a, on the section perpendicular to the measurement face 451a of the flow-amount measuring unit 451, in parallel to the forward direction F of the gas to be measured 30. This arrangement allows the flow along the first slope face 371 to facilitate introduction of the flow in the counterflow direction R of the gas to be measured 30 deviating from the second passage 352 side to the first passage 351 side, into the second passage 352. In a case where the extended line L1 of the first slope face 371 and the extended line L2 of the measurement face 451a intersect on the downstream side with respect to the end portion on the downstream side of the flow-channel exposed portion 430 of the circuit package 400, the deviated flow in the counterflow direction R of the gas to be measured 30, is easily introduced into the second passage 352.

As described above, the thermal flowmeter 300 of the present embodiment inhibits the flow rate to be measured by the flow-amount measuring unit 451, from falling below the actual flow rate even while the gas to be measured 30 is pulsating, so that the measurement error can fall below that of the conventional one.

### Second Embodiment

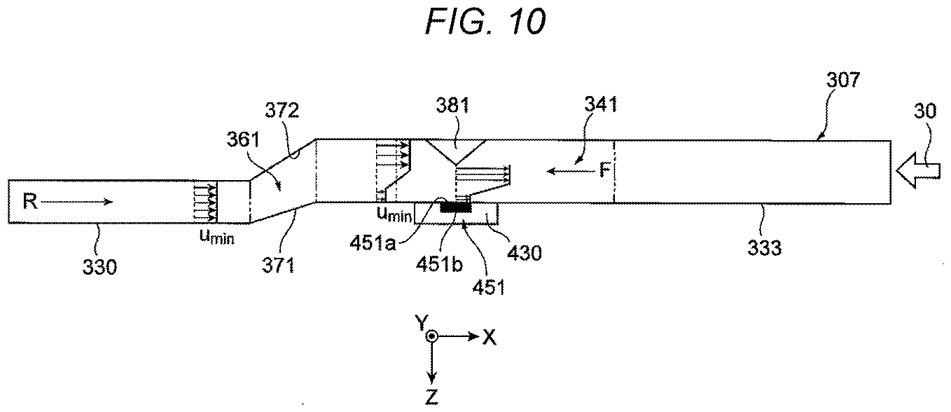

Next, a second embodiment of the thermal flowmeter of the present invention will be described with FIG. 10 with the assistance of FIGS. 1 to 4 and FIGS. 6A to 7B. FIG. 10 is a schematic developed view of a sub-passage 307 of a thermal flowmeter of the present embodiment, FIG. 10 being equated to FIG. 5 of the thermal flowmeter 300 of the first embodiment described above.

For the thermal flowmeter of the present embodiment, differences from the thermal flowmeter 300 of the first embodiment described above illustrated in FIG. 5, will be mainly described below. Except for a configuration to be described below, the configuration of the thermal flowmeter of the present embodiment is similar to that of the thermal flowmeter 300 of the first embodiment described above. Thus, parts similar to those of the thermal flowmeter 300 of the first embodiment are denoted with the same reference signs, and thus the descriptions thereof will be appropriately omitted.

Similarly to the thermal flowmeter 300 of the first embodiment described above, the thermal flowmeter of the present embodiment, includes the sub-passage 307 that takes in part of gas to be measured 30 that is fluid flowing in a main passage 124, and a flow-amount measuring unit 451 disposed in the sub-passage 307. Note that, in the thermal flowmeter of the present embodiment, the flow-amount measuring unit 451 and a flow-channel exposed portion 430 of a circuit package 400 are embedded in a wall face of a flow channel for measurement 341 of the sub-passage 307, demarcating the flow channel for measurement 341.

In the thermal flowmeter of the present embodiment, the sub-passage 307 has the flow channel for measurement 341 facing a measurement face 451a of the flow-amount measuring unit 451, and a slope passage 361 provided on the downstream side in the forward direction F of the gas to be measured 30 that is the fluid flowing in the flow channel for measurement 341, with respect to the flow channel for measurement 341. In the thermal flowmeter of the present embodiment, the slope passage 361 has a first slope face 371 sloping from the measurement face 451a side to the back face 451b side of the flow-amount measuring unit 451 in the forward direction F of the gas to be measured 30.

Note that the first slope face 371 is provided on a wall face on the flow-amount measuring unit 451 side of the sub-passage 307 in a direction (Z axis direction) perpendicular to the measurement face 451a of the flow-amount measuring unit 451. A protrusion portion 381 is provided on a wall face opposed to the flow-amount measuring unit 451 of the sub-passage 307 in the direction (Z axis direction) perpendicular to the measurement face 451a of the flow-amount measuring unit 451. The protrusion portion 381 protrudes from the wall face opposed to the flow-amount measuring unit 451 of the sub-passage 307, toward the measurement face 451a of the flow-amount measuring unit 451.

In the thermal flowmeter of the present embodiment having the configuration, the gas to be measured 30 to flow in the counterflow direction R from the downstream side to the upstream side in the forward direction F of the gas to be measured 30 in the flow channel for measurement 341 while the gas to be measured 30 is pulsating, flows along the first slope face 371 of the slope passage 361 and then deviates in a direction receding from the measurement face 451a of the flow-amount measuring unit 451. This arrangement allows the gas to be measured 30 flowing in the counterflow R between the protrusion portion 381 and the measurement face 451a of the flow-amount measuring unit 451, to rise in flow rate at a position apart from the measurement face 451a of the flow-amount measuring unit 451 and to fall in flow rate in the neighborhood of the measurement face 451a of the flow-amount measuring unit 451.

As a result, the thermal flowmeter of the present embodiment can equalize the time average value in flow rate to be measured by the thermal flowmeter while the gas to be measured 30 is pulsating, substantially to the actual flow rate of the gas to be measured, similarly to the thermal flowmeter 300 of the first embodiment. Therefore, according to the thermal flowmeter of the present embodiment, a measurement error can fall below that of a conventional one, similarly to thermal flowmeter 300 of the first embodiment.

### Third Embodiment

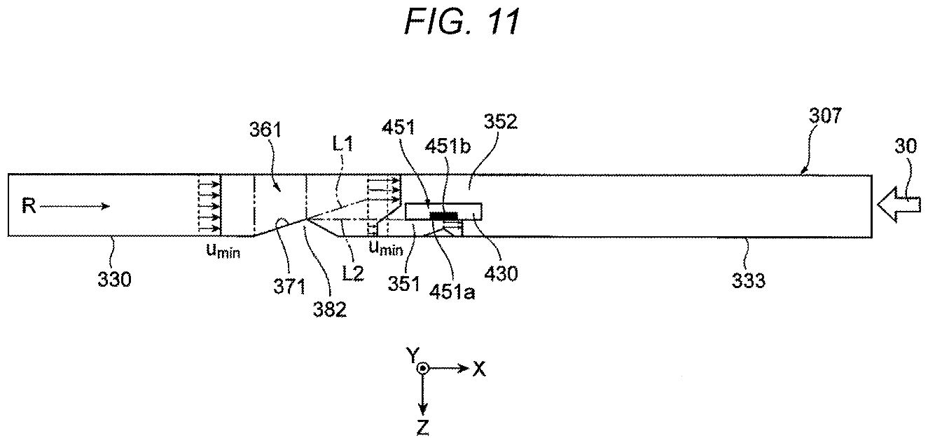

Next, a third embodiment of the thermal flowmeter of the present invention will be described with FIG. 11 with the assistance of FIGS. 1 to 4 and FIGS. 6A to 7B. FIG. 11 is a schematic developed view of a sub-passage 307 of a thermal flowmeter of the present embodiment, FIG. 11 being equated to FIG. 5 of the thermal flowmeter 300 of the first embodiment described above.

For the thermal flowmeter of the present embodiment, differences from the thermal flowmeter of the second embodiment described above illustrated in FIG. 10, will be mainly described below. Except for a configuration to be described below, the configuration of the thermal flowmeter of the present embodiment is similar to that of the thermal flowmeter of the second embodiment described above. Thus, parts similar to those of the thermal flowmeter of the second embodiment and the thermal flowmeter 300 of the first embodiment are denoted with the same reference signs, and thus the descriptions thereof will be appropriately omitted.

As illustrated in FIG. 11, the thermal flowmeter of the present embodiment includes a protrusion portion 382 on a wall face on the first passage 351 side from the opposed wall faces of the sub-passage 307 in the thickness direction (Z axis direction) of a casing 310, the protrusion portion 382 protruding in the thickness direction (Z direction) of a casing 310. The protrusion portion 382 has a first slope face 371. A slope passage 361 in the sub-passage 307 of the thermal flowmeter of the present embodiment, has the range in which the first slope face 371 is provided.

The first slope face 371 illustrated in FIG. 11 provided on the first passage 351 side with respect to a flow-amount measuring unit 451, slopes from the second passage 352 side to the first passage 351 side with respect to a forward direction F, similarly to the first slope face 371 illustrated in FIG. 5. The first slope face 371 illustrated in FIG. 11 has the extended line L1 of the first slope face 371 and the extended line L2 of a measurement face 451a intersecting on the downstream side in the forward direction F with respect to the measurement face 451a and on the downstream side in the forward direction F with respect to a flow-channel exposed portion 430 of a circuit package 400, the flow-channel exposed portion 430 functioning as a supporting portion for the flow-amount measuring unit 451.

Therefore, according to the thermal flowmeter of the present embodiment, the first slope face 371 of the slope passage 361 can deviate the flow in the counterflow direction R of gas to be measured 30, from the first passage 351 side to the second passage 352 side, so that an effect similar to those of the thermal flowmeter of the second embodiment and the thermal flowmeter 300 of the first embodiment described above can be acquired.

### Fourth Embodiment

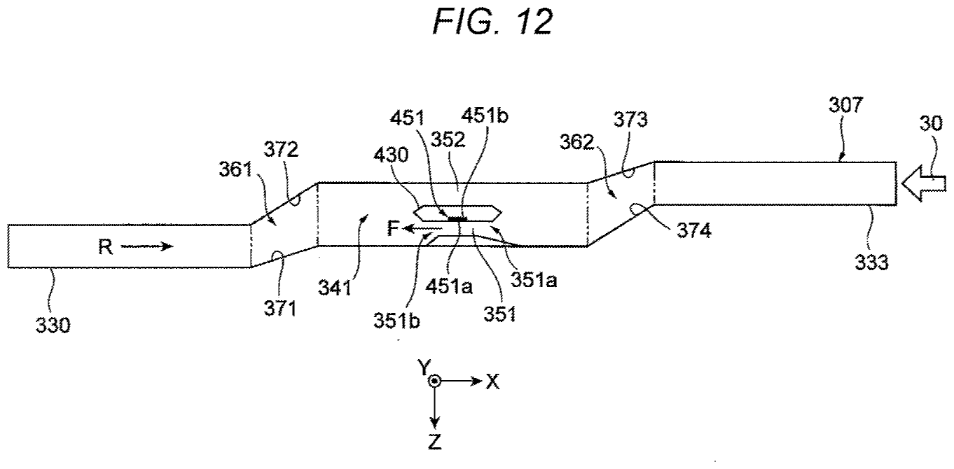

Next, a fourth embodiment of the thermal flowmeter of the present invention will be described with FIG. 12 with the assistance of FIGS. 1 to 4 and FIGS. 6A to 7B. FIG. 12 is a schematic developed view of a sub-passage 307 of a thermal flowmeter of the present embodiment, FIG. 12 being equated to FIG. 5 of the thermal flowmeter 300 of the first embodiment described above.

For the thermal flowmeter of the present embodiment, differences from the thermal flowmeter 300 of the first embodiment described above illustrated in FIG. 5, will be mainly described below. Except for a configuration to be described below, the configuration of the thermal flowmeter of the present embodiment is similar to that of the thermal flowmeter 300 of the first embodiment described above. Thus, parts similar to those of the thermal flowmeter 300 of the first embodiment are denoted with the same reference signs, and thus the descriptions thereof will be appropriately omitted.

In the thermal flowmeter of the present embodiment, the sub-passage 307 has a second slope passage 362 on the upstream side in a forward direction F with respect to an inlet 351a of a first passage 351. The second slope passage 362 has a third slope face 373 on the first passage 351 side with respect to a flow-amount measuring unit 451, the third slope face 373 sloping from the second passage 352 side to the first passage 351 side with respect to the forward direction F.

In the thermal flowmeter of the present embodiment, the second slope passage 362 has a fourth slope face 374 opposed to the third slope face 373 in a direction (Z axis direction) perpendicular to a measurement face 451a. The fourth slope face 374 slopes from the second passage 352 side to the first passage 351 side with respect to the forward direction F.

Furthermore, in the thermal flowmeter of the present embodiment, the sub-passage 307 has a portion on the upstream side in the forward direction F with respect to the second slope passage 362, the portion being provided on the second passage 352 side with respect to the first passage 351 in the direction (Z axis direction) perpendicular to the measurement face 451a. In other words, the sub-passage 307 has a slope passage 361 and the second slope passage 362 on the upstream side and the downstream side in the forward direction F of a flow channel for measurement 341, the slope passage 361 and the second slope passage 362 having point symmetry with respect to a point on the flow-amount measuring unit 451.

The thermal flowmeter of the present embodiment having the configuration similar to that of the thermal flowmeter 300 of the first embodiment described above, acquires an effect similar to that of the thermal flowmeter 300 of the first embodiment described above. In addition, in the thermal flowmeter of the present embodiment having the second slope passage 362, the third slope face 373 can deviate, from the second passage 352 side to the first passage 351 side, gas to be measured 30 flowing in the forward direction F from the upstream side in the forward direction F of the gas to be measured 30 in the flow channel for measurement 341.

This arrangement enables the amount of flow of the gas to be measure 30 flowing in the forward direction F (X axis negative direction) in the first passage 351 while the gas to be measured 30 is pulsating, to exceed that in a conventional one. This arrangement can bring the average value uave in flow rate to be measured by the thermal flowmeter, closer to the average value u0 of the actual flow rate of the gas to be measured 30, with a positively shift of the maximum value umax of the measured value of the thermal flowmeter illustrated in FIG. 9.

Furthermore, in the thermal flowmeter of the present embodiment, the second slope passage 362 has the fourth slope face 374 opposed to the third slope face 373, the fourth slope face 374 sloping from the second passage 352 side to the first passage 351 side with respect to the forward direction F. This arrangement can inhibit an eddy from occurring in the flow in the forward direction F of the gas to be measured 30 deviating due to the third slope face 373 of the second slope passage 362, so that the amount of flow of the gas to be measured 30 flowing in the forward direction F in the first passage 351 can increase.

Therefore, the thermal flowmeter of the present embodiment effectively inhibits the flow rate to be measured by the flow-amount measuring unit 451, from falling below the actual flow rate even while the gas to be measured 30 is pulsating, so that a measurement error can fall below that of the conventional one.

The embodiments of the present invention have been described in detail above with the drawings, but the specific configurations are not limited to the embodiments. Thus, for example, alterations in design made without departing from the scope of the spirit of the present invention are included in the present invention.

### REFERENCE SIGNS LIST

30 gas to be measured (fluid)
124 main passage
300 thermal flowmeter
307 sub-passage
307A straight passage
307B branch passage
310 casing
312 first outlet (discharge outlet)
341 flow channel for measurement
351 first passage
351a inlet of first passage
352 second passage
352b outlet of second passage
361 slope passage
362 second slope passage
371 first slope face
372 second slope face
373 third slope face
374 fourth slope face
451 flow-amount measuring unit
451a measurement face
451b back face
F forward direction
L1 extended line of first slope face
L2 extended line of measurement face
θ2 slope angle of second slope face
θ1 slope angle of first slope face

1. A thermal flowmeter comprising:
a sub-passage configured to take in part of fluid flowing in a main passage; and
a flow-amount measuring unit disposed in the sub-passage, wherein
the sub-passage has: a first passage provided on a measurement face side of the flow-amount measuring unit; a second passage provided on a back face side of the flow-amount measuring unit; and a slope passage provided on a downstream side in a forward direction of the fluid in the second passage with respect to an outlet of the second passage, and
the slope passage has a first slope face on a first passage side with respect to the flow-amount measuring unit, the first slope face sloping from a second passage side to the first passage side with respect to the forward direction.

2. The thermal flowmeter according to claim 1, wherein
the slope passage has a second slope face opposed to the first slope face in a direction perpendicular to a measurement face of the flow-amount measuring unit, and
the second slope face slopes from the second passage side to the first passage side with respect to the forward direction.

3. The thermal flowmeter according to claim 2, wherein a slope angle of the second slope face with respect to the forward direction is larger than a slope angle of the first slope face with respect to the forward direction.

4. The thermal flowmeter according to claim 1, wherein the sub-passage has a portion on the downstream side in the forward direction with respect to the slope passage, the portion being provided on the first passage side with respect to the second passage in a direction perpendicular to a measurement face of the flow-amount measuring unit.

5. The thermal flowmeter according to claim 1, wherein, on a section perpendicular to a measurement face of the flow-amount measuring unit, in parallel to the forward direction, the sub-passage has an extended line of the first slope face and an extended line of the measurement face intersecting on the downstream side in the forward direction with respect to the measurement face.

6. The thermal flowmeter according to claim 1, wherein
the sub-passage has: a straight passage configured to take in the part of the fluid flowing in the main passage; a discharge outlet configured to discharge the part of the fluid flowing in the straight passage; and a branch passage branching from the straight passage on an upstream side in
the forward direction of the fluid flowing in the straight passage with respect to the discharge outlet, and the first passage, the second passage, and the slope passage are provided in the branch passage.

7. The thermal flowmeter according to claim 1, comprising
a flat casing disposed in the main passage, the casing demarcating the sub-passage, wherein
a measurement face of the flow-amount measuring unit is perpendicular to a thickness direction of the casing.

8. The thermal flowmeter according to claim 1, wherein
the sub-passage has a second slope passage on an upstream side in the forward direction with respect to an inlet of the first passage, and
the second slope passage has a third slope face on the second passage side with respect to the flow-amount measuring unit, the third slope face sloping from the second passage side to the first passage side with respect to the forward direction.

9. The thermal flowmeter according to claim 8, wherein
the second slope passage has a fourth slope face opposed to the third slope face in a direction perpendicular to a measurement face of the flow-amount measuring unit, and
the fourth slope face slopes from the second passage side to the first passage side with respect to the forward direction.

10. A thermal flowmeter comprising:
a sub-passage configured to take in part of fluid flowing a main passage; and
a flow-amount measuring unit disposed in the sub-passage, wherein
the sub-passage has: a flow channel for measurement facing a measurement face of the flow-amount measuring unit; and a slope passage provided on a downstream side in a forward direction of the fluid flowing in the flow channel for measurement with respect to the flow channel for measurement, and
the slope passage has a first slope face sloping from a measurement face side to a back face side of the flow-amount measuring unit in the forward direction.
